(19) United States
(12) Patent Application Publication
(10) Pub. No.: US 2017/0306921 A1
(43) Pub. Date: Oct. 26, 2017

(54) HIGH TORQUE WIND TURBINE BLADE, TURBINE, GENERATOR, AND ASSOCIATED SYSTEMS AND METHODS

(71) Applicant: Primo Wind, Inc., San Diego, CA (US)

(72) Inventor: Gary Lynn Young, Shawnee, OK (US)

(21) Appl. No.: 15/462,634

(22) Filed: Mar. 17, 2017

Related U.S. Application Data
(63) Continuation-in-part of application No. 29/570,046, filed on Jul. 3, 2016.
(60) Provisional application No. 62/347,334, filed on Jun. 8, 2016.
(60) Provisional application No. 62/326,750, filed on Apr. 23, 2016.

(51) Int. Cl. F03D 1/06; F03D 9/25; F03D 13/20

(52) U.S. Cl. CPC F03D 1/0675; F03D 13/20; F03D 1/0666; F03D 9/25; F05B 2240/221; F05B 2250/16; F05B 2280/4003; F05B 2220/706

(57) ABSTRACT

A blade for a wind turbine can include an elongated sheet having a root, a tip positioned opposite the root, a leading edge spanning between the root and the tip along a length of the sheet, and a trailing edge positioned opposite the leading edge and spanning between the root and the tip along the length of the sheet. The sheet can be curved such that the root and the tip are curved and a region between the tip and the root is curved. The tip can be twisted relative to the root by a washout angle of 18 degrees. The blade can include high density polyethylene, such as hexene copolymer high density polyethylene. A wind turbine can include a mounting plate and a plurality of turbine blades connected to the mounting plate. In addition, a rotor for a radial flux, permanent magnet alternator can be fabricated from non-magnetic material.

### CROSS-REFERENCE TO RELATED APPLICATION(S)

The present application claims priority to U.S. Provisional Patent Application No. 62/347,334, entitled “Wind Turbine Blade, Turbine and Generator”, filed Jun. 8, 2016; U.S. Design Patent Application No. 29/570,046, entitled “Wind Turbine”, filed Jul. 3, 2016; and U.S. Provisional Patent Application No. 62/326,750, filed Apr. 23, 2016, entitled “Permanent Magnet Alternator with Non-magnetic Rotor”; each of which is incorporated herein in its entirety by reference.

### TECHNICAL FIELD

The present technology is directed generally to a blade design for use in a wind turbine, wind turbines implementing the blade design (such as a plurality of the blades), a wind turbine generator assembly implementing a wind turbine, and an alternator suitable for use with wind turbines and other devices.

### BACKGROUND

Current developments in wind turbine design often focus on large scale kilowatt and megawatt installations. In such cases, fewer, very-large blades have been found to be most efficient. For example, adding more than 3 blades to very large turbines has been reported to produce diminishing returns in energy production. Additionally, more blades on very large scale turbines results in a much noisier turbine due in part to the aerodynamic effects of air flowing over the blade surfaces. Moreover, large commercial turbine power generating systems need to be located in specific high-wind locations, such as the crests of hills in windy geographies.

Smaller scale applications, such as those related to domestic, marine, and remote field power generation, have different requirements. For example, domestic or mobile turbines, by their nature, may be placed in locations with inconsistent or low winds.

Current turbines of any size produce undesirable levels of noise, at least in part because of aerodynamic effects of current blade designs chopping the air (a constant whooshing sound). Accordingly, in some instances, users may lock such turbines and avoid their use when people are nearby, such as when a boat is occupied or when people nearby are sleeping. If a user chooses to lock a turbine at night to reduce noise, the undesirable noise has the ultimate effect of reducing the turbine's efficacy. Such undesirable noise levels may also contribute to the relatively higher popularity of solar energy for domestic, home-based, and/or off-grid power generation, despite the fact that solar power does not work at night, while wind power does. And current turbines are less portable than solar panels or batteries, so solar power and batteries are a predominant power source for remote uses by hikers or others in remote areas.

Accordingly, there is a need for quieter turbines, turbines that can generate power at low wind speeds, turbines with improved efficiency, and—for many applications—turbines and related assemblies for power generation that are light weight, resilient, and/or portable.

Radial flux, permanent magnet alternators presently used in small wind turbines typically employ a rotor fabricated from magnetic material to which a number of permanent magnets are attached. Magnetic materials are typically based on iron alloys which are quite heavy, adding significantly to the weight of the unit and diminishing its portability. Additionally, a portion of the magnetic flux directed between the permanent magnets flows through the rotor body rather than through the stator coils, thereby reducing the electrical power generation efficiency of the unit. Thus, a lightweight yet high efficiency radial flux permanent magnet alternator is also desired.

### SUMMARY

The following summary is provided for the convenience of the reader and identifies several representative embodiments of the disclosed technology. Such representative embodiments are examples only and do not constitute the full scope of the invention.

Representative embodiments of the present technology include a wind turbine generator assembly for converting wind into electrical energy, the assembly having a wind turbine, a generator positioned to support the wind turbine and configured to receive rotational force from the wind turbine and convert the rotational force to electrical energy, a fin connected to the generator and positioned on a side of the generator opposite the wind turbine, and a support structure positioned to support the generator, the support structure configured to allow the generator to rotate relative to the support structure. The wind turbine can include a mounting plate having a central region and a plurality of arms extending outwardly from the central region, wherein the plurality of arms is arranged symmetrically around the central region and each arm includes at least one mounting hole. The wind turbine can further include a plurality of turbine blades, each turbine blade being connected to a corresponding arm of the plurality of arms via a corresponding mounting hole of the at least one mounting hole.

In some embodiments, at least one of the turbine blades can include an elongated quadrilateral sheet having a root, a tip positioned opposite the root, a leading edge spanning between the root and the tip along a length of the blade, and a trailing edge positioned opposite the leading edge and spanning between the root and the tip along the length of the blade. The blade can have a radius of curvature along its length forming a concave face oriented away from the mounting plate. The root and the tip can be rotated relative to each other such that the blade is twisted along its length. In some embodiments, the support structure can include a shaft connected to a tripod.

In another representative embodiment of the present technology, a wind turbine can include a mounting plate having a central region and a plurality of arms extending outwardly from the central region, wherein the plurality of arms is arranged symmetrically around the central region and each arm includes at least one mounting hole. The wind turbine can include a plurality of turbine blades, each turbine blade being connected to a corresponding arm of the plurality of arms via a corresponding mounting hole of the at least one mounting hole. At least one of the turbine blades can include an elongated quadrilateral sheet with a root, a tip positioned opposite the root, a leading edge spanning between the root and the tip along a length of the blade, and a trailing edge positioned opposite the leading edge and spanning between the root and the tip along the length of the blade. The blade can have a radius of curvature along its length forming a concave face oriented away from the mounting plate. The root and the tip can be rotated relative to each other such that the blade is twisted along its length. In some embodiments, the root and the tip can be rotated relative to each other by a washout angle of 18 degrees. In some embodiments, each blade of the plurality of blades can partially overlap another blade of the plurality of blades. The wind turbine can include nine arms and nine blades. In some embodiments, the arms can be tapered along their length and the leading edge of the at least one turbine blade can be aligned with an edge of its corresponding arm. The blade can be formed at least in part using hexene copolymer high density polyethylene. In some embodiments, a turbine blade is attached to its corresponding arm via a portion of the turbine blade that is closer to the trailing edge than to the leading edge.

In another representative embodiment of the present technology, a blade for a wind turbine includes an elongated quadrilateral sheet with a root, a tip positioned opposite the root, a leading edge spanning between the root and the tip along a length of the sheet, and a trailing edge positioned opposite the leading edge and spanning between the root and the tip along the length of the sheet. The sheet can be curved about a longitudinal axis such that the root is curved, the tip is curved, and a region between the tip and the root is curved. The tip can be twisted relative to the root by a washout angle of between 16 and 20 degrees. In some embodiments, the washout angle can be 18 degrees. In some embodiments, a radius of curvature of the root can be equal to a radius of curvature of the tip. The radius of curvature of the root can be 7 inches. The root can be longer than the tip. In some embodiments, at least a portion of the trailing edge can be straight and the leading edge can have a radius of curvature between the root and the tip. In some embodiments, the radius of curvature of the leading edge can be 10 feet. The blade can include or be formed at least in part from hexene copolymer high density polyethylene. In some embodiments, a ratio of a length of the trailing edge to a width of the root to a width of the tip can be 8:2:1. At least part of the curve of the sheet about the longitudinal axis can be parabolic.

In a representative embodiment, the washout angle can be 18 degrees, a radius of curvature of the root can be 7 inches, a radius of curvature of the tip can be 7 inches, the leading edge can have a radius of curvature between the root and the tip of 10 feet, the blade can have an overall length between 24 and 34.5 inches, and the blade can include high density polyethylene (HDPE).

In another representative embodiment of the present technology, a rotor for a radial flux permanent magnet alternator can include a rotor shaft, a non-magnetic cylindrical hub operably connected to the rotor shaft, and a plurality of permanent magnets affixed to the hub. The permanent magnets can establish a magnetic flux in paths external to the rotor for coupling one or more stator windings to induce a voltage in the stator windings.

Other features and advantages will appear hereinafter. The features described above may be used separately or together, or in various combinations of one or more of them.

### BRIEF DESCRIPTION OF THE DRAWINGS

In the drawings, wherein the same reference number indicates the same element throughout the views:

FIG. 1 illustrates a view of a turbine blade in accordance with an embodiment of the present technology.

FIG. 2a is a partially schematic line or wire diagram to illustrate some of the curvature of the turbine blade shown in FIG. 1.

FIG. 2b is a partially schematic shaded view of the turbine blade shown in FIG. 1, with the same perspective as in FIG. 2a.

FIG. 3 illustrates an end view of the turbine blade shown in FIGS. 1, 2a, and 2b, with the root in the foreground, extending to the tip in the background.

FIG. 4 illustrates a mounting plate for supporting one or more turbine blades (for example, 9 of the turbine blades shown in FIGS. 1-3) in accordance with an embodiment of the present technology.

FIG. 5 illustrates a front view of a turbine constructed using the turbine blades shown in FIGS. 1-3 and the mounting plate shown in FIG. 4, in accordance with an embodiment of the present technology.

FIG. 6 illustrates a partially schematic rear view of the turbine shown in FIG. 5 in which the turbine blades, mounting plate, and mounting holes of the mounting plate are visible.

FIG. 7 illustrates a side view of a turbine (such as a turbine shown in FIGS. 5-6), in which the turbine is attached to a generator drive shaft.

FIG. 8 illustrates a representative wind turbine generator assembly in accordance with an embodiment of the present technology.

FIG. 9 illustrates a schematic view of a prior art permanent magnet alternator.

FIG. 10 illustrates a schematic view of an embodiment of an improved permanent magnet alternator.

FIG. 11 illustrates an isometric view of the non-magnetic rotor shown in FIG. 10.

FIG. 12 illustrates an isometric drawing of a non-magnetic rotor similar to the non-magnetic rotor shown and described with respect to FIG. 10 and including skewed magnet slots.

### DETAILED DESCRIPTION

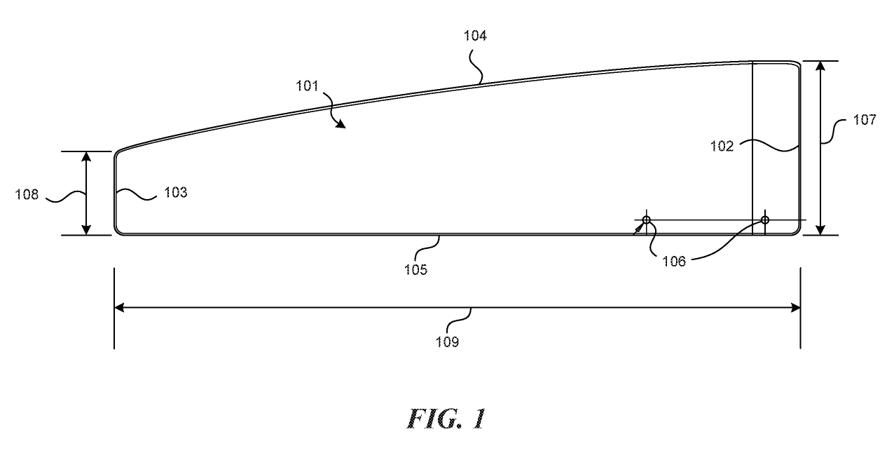

The present technology is directed to a high torque wind turbine blade, a turbine, a generator, a rotor for a radial flux permanent magnet alternator, and associated systems and methods. Various embodiments of the technology will now be described. The following description provides specific details for a thorough understanding and an enabling description of these embodiments. One skilled in the art will understand, however, that the invention may be practiced without many of these details. Additionally, some well-known structures or functions may not be shown or described in detail so as to avoid unnecessarily obscuring the relevant description of the various embodiments. Accordingly, the technology may include other embodiments with additional elements or without several of the elements described below with reference to FIGS. 1-12, which illustrate examples of the technology.

The terminology used in the description presented below is intended to be interpreted in its broadest reasonable manner, even though it is being used in conjunction with a detailed description of certain specific embodiments of the technology. Certain terms may even be emphasized below; however, any terminology intended to be interpreted in any restricted manner will be overtly and specifically defined as such in this detailed description section.

Where the context permits, singular or plural terms may also include the plural or singular term, respectively. Moreover, unless the word “or” is expressly limited to mean only a single item exclusive from the other items in a list of two or more items, then the use of “or” in such a list is to be interpreted as including (a) any single item in the list, (b) all of the items in the list, or (c) any combination of items in the list. Further, unless otherwise specified, terms such as “attached” or “connected” are intended to include integral connections, as well as connections between physically separate components.

Specific details of several embodiments of the present technology are described herein with reference to wind turbines. The technology may also be used in other areas or industries in which fluid flow is used to generate electricity and/or to rotate a turbine for other applications, including, for example, flow of a liquid. Conventional aspects of some elements of the technology may be described in reduced detail herein for efficiency and to avoid obscuring the present disclosure of the technology.

### Wind Turbine Blade

The present technology includes a turbine blade that provides high torque relative to its size.

As will be described in additional detail below, a turbine blade in accordance with an embodiment of the present technology may be formed from a curved sheet (such as a curved elongated quadrilateral sheet). Such a curved sheet may also be twisted to improve efficiency of the turbine blade and the turbine in which it may be used. In some embodiments, an edge of a representative blade between the root and the tip may be curved. In a representative embodiment, a blade may have 18 degrees of twist, regardless of the overall size or length of the blade or other dimensions. The twist of a blade may be referred to as “washout.” Although other suitable degrees of twist (washout) may be used in accordance with various embodiments of the present technology (such as a washout angle between 16 and 20 degrees), the inventor has discovered that 18 degrees of washout has improved (e.g., optimal) performance to prevent a negative blade tip stall condition and ensure that positive wind pressure is located on the correct side of the tips throughout the largest range of wind speeds. The shape of each blade is also designed to maintain even pressure distributed along the whole face of the blade. Such even pressure distribution and resistance to blade tip stall condition improves performance and reduces wind noise.

Turning now to the figures, FIG. 1 illustrates a view of a turbine blade 101 in accordance with an embodiment of the present technology. The blade can be generally shaped as a quadrilateral or elongated quadrilateral sheet with a foot or root 102 on one side and a tip 103 opposite the root 102. A trailing edge 105, which may be straight in some embodiments (or curved in others), spans a distance or length 109 between the root 102 and the tip 103. A leading edge 104, which may be curved in some embodiments (or straight in others), is positioned opposite the trailing edge 105 and spans between the root 102 and the tip 103. A width 107 of the root 102 can be larger than a width 108 of the tip 103. For example, in a representative embodiment, the width 107 of the root 102 is approximately twice the width 108 of the tip 103. In other embodiments, the width 107 of the root 102 can have other suitable sizes relative to the width 108 of the tip 103.

One or more mounting holes 106 can be located along the trailing edge 105 near the root 102, or they may be positioned in other suitable locations for mounting the turbine blade 101 to a hub or other structure, as described in additional detail below. For example, the mounting holes 106 can have a diameter of 0.25 inches or another suitable diameter. The mounting holes 106 can be positioned at a distance of 0.5 to 0.6 inches (such as 0.55 inches) from the trailing edge 105. In an embodiment having two mounting holes, they can be spaced apart by 4.25 inches, or by any other suitable distance. They may be positioned 1.2 to 1.3 inches away from the root 102, or other suitable distances. A region of the blade 101 near and/or surrounding the mounting holes 106 can be flat in some embodiments to improve mounting and/or to help the blades 101 to have a suitable angle of attack against the incoming wind.

A turbine blade 101 in accordance with embodiments of the present technology can have a length 109 of approximately 15 inches to approximately 36 inches, or larger or smaller lengths depending on application and power generation needs. For example, in representative embodiments, a turbine blade 101 can have a length of 24.6 inches, 32.5 inches, or other suitable lengths. For a blade having a length 109 of 24.6 inches, the root 102 can have a width 107 of approximately 6.2 inches and the tip 103 can have a width 108 of approximately 4.7 inches. In further embodiments, the blade 101 can have a width 107 at the root 102 of approximately 8.5 inches, and a width 108 at the tip 103 of approximately 3.25 inches. For a blade having a length 109 of 32.5 inches, the root 102 can have a width 107 of approximately 8.0 inches and the tip 103 can have a width 108 of approximately 3.25 inches. A turbine blade 101 in accordance with various embodiments can have other suitable dimensions. For example, a ratio of the length 109 of the trailing edge 105 to the width 107 of the root 102 to the width 108 of the tip 103 can be approximately 8:2:1. In a blade having a length of 32.5 inches, a radius of curvature of the leading edge 104 can be approximately 10 feet, or other suitable dimensions. Edges of the blade 101 can be chamfered or rounded to reduce drag, reduce weight, and/or for other reasons. For example, the leading edge 104, the trailing edge 105, and/or other edges can be chamfered or rounded.

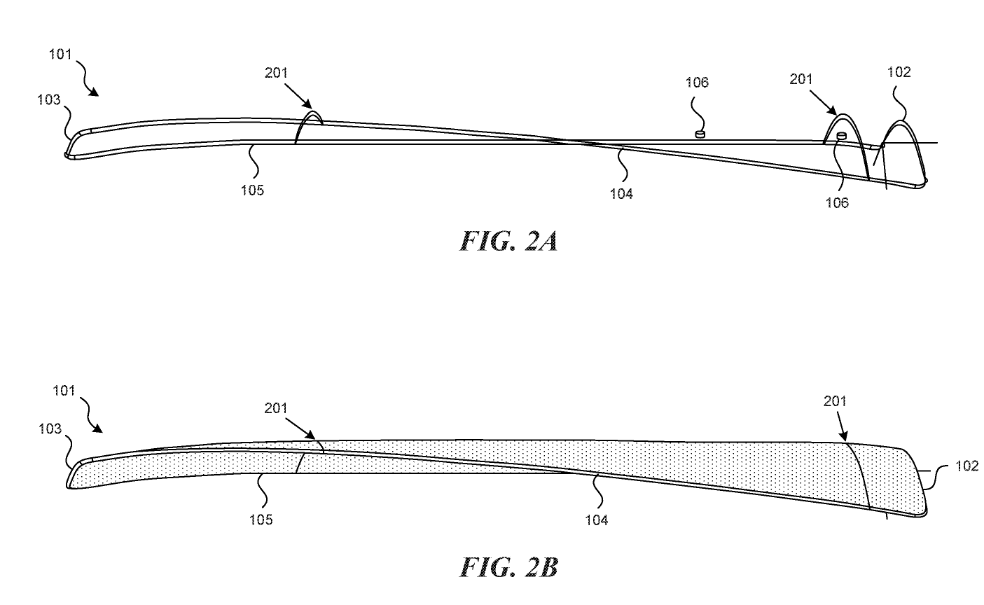

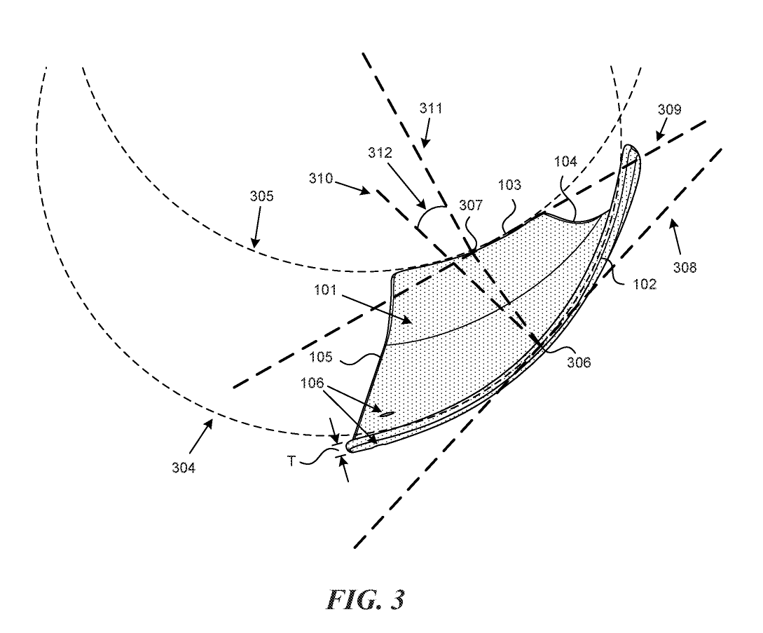

FIGS. 2a and 2b illustrate additional views of the turbine blade 101 shown in FIG. 1. FIG. 2a is a partially schematic line or wire diagram to illustrate some of the curvature of the turbine blade 101 shown in FIG. 1. FIG. 2b is a partially schematic shaded view of the turbine blade 101 shown in FIG. 1, with the same perspective as in FIG. 2a. In each of FIGS. 2a and 2b, as described above, the turbine blade 101 has a root 102, a tip 103 opposite the root 102, a leading edge 104 spanning between the root 102 and the tip 103, and a trailing edge 105 spanning between the root 102 and the tip 103. The mounting holes 106 are positioned along the trailing edge 105 and near the root 102. Lines 201 are provided to illustrate the curvature of the turbine blade 101 about a long or longitudinal axis (e.g., along or aligned with the length 109 shown in FIG. 1) running from the root 102 to the tip 103. For example, the blade 101 can be curved about an axis extending from the root 102 to the tip 103 between the leading edge 104 and the trailing edge 105. In other words, the radius of curvature is generally oblique to the length of the blade 101 or transverse to the length of the blade 101 (such as perpendicular). In a representative embodiment, such as in a 32.5 inch blade, a radius of curvature of the lines 201 can be about 7 inches, or it can have other suitable dimensions. In a representative embodiment, the turbine blade 101 can have a parabolic shape and a curvature at an apex of a parabola or centerline of the blade can be 7 inches. In some embodiments, the radius of curvature need not be uniform along the length 109 from the root 102 to the tip 103. In a further representative embodiment, the turbine blade 101 is twisted (“washout”) about an axis running the length of the turbine blade 101, such as a centerline, by 18 degrees, as further illustrated in FIG. 3. Such a compound curve provides advantages such as structural integrity while distributing even wind pressure across the face of the blade 101.

FIG. 3 generally illustrates an end view of the turbine blade 101 shown in FIGS. 1, 2a, and 2b, with the root 102 in the foreground, extending to the tip 103 in the background. A curvature 304 of the root 102 is depicted as a dashed line (304). A curvature 305 of the tip 103 is also depicted as a dashed line (305). In a representative embodiment (such as a blade having a length of 32.5 inches), the radius of the curvature 304 of the root 102 and the radius of the curvature 305 of the tip 103 is approximately 7 inches. In other embodiments, the radius of the curvatures 304 and 305 may be different, or the 7-inch curvature can be used with other lengths of blades. For example, the radius of curvature 305 of the tip 103 and/or the radius of curvature 304 of the root 102 may be between approximately 3 inches and 7 inches on blades of various lengths. The blade 101 can have a thickness T in the range of 3 millimeters to 6 millimeters, for example, or it may have another suitable thickness.

In a representative embodiment, the turbine blade 101 has a parabolic shape. For example, the curvature 304 and/or 305 may be parabolic. In such embodiments, the radius of curvatures 304 and/or 305 can be measured at a center point or vertex of such a parabolic shape, at a central point along the root 102 or the tip 103.

FIG. 3 also illustrates the twist, or washout, of the blade 101. The twist can be measured by an angle 312 between a first line 310 and a second line 311, which can be explained as follows. A first center point 306 of the root 102 is positioned between the leading and trailing edges 104, 105. A first tangent line 308 is tangent to the curvature 304 of the root 102 at the first center point 306. The first line 310 is perpendicular to the first tangent line 308 at the first center point 306. Similarly, a second center point 307 of the tip 103 is positioned between the leading and trailing edges 104, 105. A second tangent line 309 is tangent to the curvature 305 of the tip 103 at the second center point 307. The second line 311 is perpendicular to the second tangent line 309 at the second center point 307. The first line 310 and the first tangent line 308 define a first plane. The second line 311 and the second tangent line 309 define a second plane parallel to the first plane. The angle 312 is the angle between the first line 310 projected onto the second plane (defined by the second line 311 and the second tangent line 309) and the second line 311. The angle 312, representing the twist or “washout” can be between 16 and 20 degrees in some embodiments.

In a representative embodiment of the present technology, the angle 312 can be 18 degrees. The inventor discovered that the 18 degree washout resists (e.g., prevents) negative blade tip stall condition and keeps positive wind pressure on the correct side of the tips at the widest range of wind speeds. Computational fluid dynamics analysis and windtunnel testing revealed that the 18 degree washout angle yields approximately 9% more energy relative to a blade having a 16 degree washout angle. Accordingly, the geometry of the blade 101 contributes to performance of a turbine using the blade 101, especially with regard to improved efficiency.

In various embodiments according to the present technology, the twist (i.e. washout or angle 312) is 18 degrees regardless of the length (e.g., length 109, see FIG. 1) of the blade 101. For example, when embodiments of the present technology are scaled up or down (such as relative to a representative length of 32.5 inches) while maintaining washout of 18 degrees, the additional length of a blade 101 does not merely become excess weight and/or surface area for drag. Rather, generally the entire face of the blade contributes substantially to providing torque for a turbine assembly of suitable sizes larger and smaller than those disclosed herein.

A blade 101 or a plurality of blades 101 according to the present technology maintain even pressure distribution along the whole face of the blade as it receives an incoming airstream or wind. Benefits to such geometric designs and pressure distribution include higher performance, increased efficiency, and reduced noise (e.g., silent or almost silent) relative to conventional turbines and/or turbine blades.

In some embodiments, a blade 101 is made of lightweight polymeric material and is especially shaped to accommodate the use of such material. In a representative embodiment, the blade 101 is made from a thermoplastic, plastic, and/or other resin such as high density polyethylene (HDPE). In some embodiments, the shape of the blade 101 accommodates such a flexible material to provide the stiffness required of a wind turbine blade. For example, under extremely high wind conditions, a turbine can be designed to flip (i.e. rotate around to face away from the wind) and the blade will flex to avoid destruction of the turbine. In other words, under normal operation, wind pushing on the front of a blade 101 will induce torque in the blade 101, which is generally stiff in that direction as a result of its curvature. But when the blade 101 receives pressure on its reverse side (the side not normally facing into the wind), it can flex, without breaking, and return to shape after the wind has diminished. Further, the flexibility of HDPE helps manage overspeed or over-revving in storms or extremely high wind conditions by slightly pitching into the wind and reducing the angle of attack (and thereby reducing the torque and speed to keep them within safe levels). Advantages of HDPE include properties resistant to extreme temperature change and flexibility with reduced risk of fracture.

In a representative embodiment of the present technology, high molecular weight HDPE can be used to form the blade, such as Hexene Copolymer HDPE Blow Molding Resin available from NOVA CHEMICALS as NOVAPOL HB-W555-A Resin. Such resin provides high rigidity, high impact strength, and high environmental stress crack resistance. The inventor discovered that such an HDPE formulation provides desirable (e.g., optimal) durability under a wide range of wind and weather conditions. For example, this material allows the blades to be bent in high winds and return to shape when winds are calm, under a wide range of temperatures, including extreme cold and heat. The material is also relatively lightweight, resulting in reduced inertia that facilitates faster spin-up times to catch optimal amounts of wind power. The strength of the material allows for high torque while keeping weight down, improving portability and overall efficiency.

In other embodiments, the blade is made from a fiber reinforced plastic or other suitable composite materials. One non-limiting example of such a material is a composite employing carbon fibers and/or glass fibers in an epoxy base. Such composites have demonstrated exceptional strength and durability combined with light weight for demanding applications in the automotive, medical and industrial industries. Additionally, these composites are relatively easy to form into precise, complex shapes without the need for precision stamping or milling operations. In yet further embodiments, other suitable materials may be used to form all or a part of the blade 101, such as high density polypropylene.

### Turbine Including Mounted Array of Blades

The present technology also includes a turbine made with a mounted array of turbine blades, such as the turbine blade 101 described above with respect to FIGS. 1-3.

With reference to FIGS. 1-3, each blade 101 can be mounted to a mounting plate (described in additional detail below) via one or more mounting holes 106 (for example, two mounting holes 106). Such mounting holes provide for proper orientation of the individual blades 101 relative to one another and to the wind direction, as illustrated and described in additional detail below. An advantage of such an attachment or mounting is that the mounting holes, in conjunction with the compound curve and shape of each blade 101, provides structural integrity for the assembly.

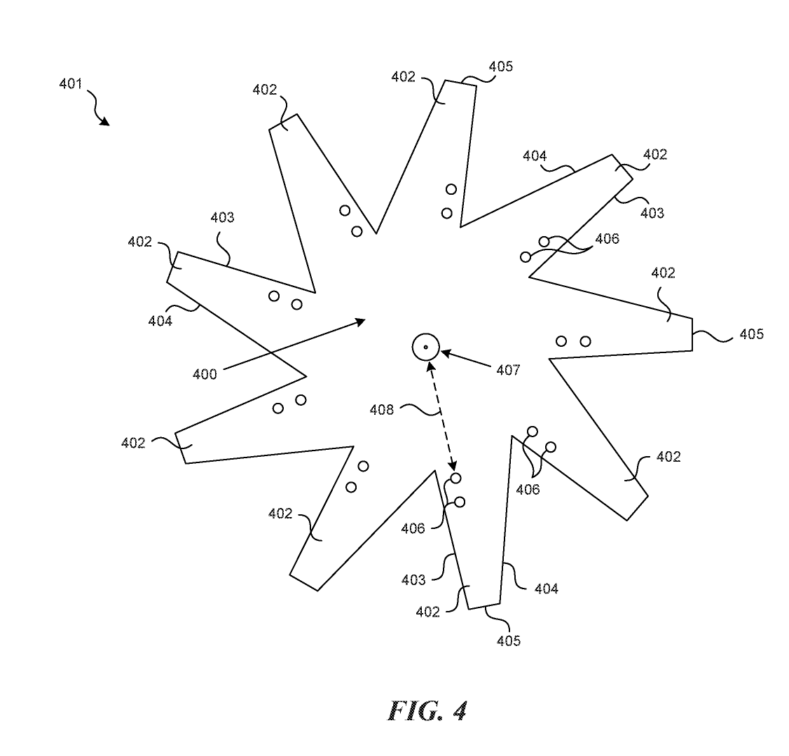

FIG. 4 illustrates a mounting plate 401 for supporting one or more turbine blades (for example, 9 turbine blades 101 described above with respect to FIGS. 1-3) in accordance with an embodiment of the present technology. The mounting plate 401 is a generally flat star- or circular-shaped plate including a flat circular central region 400 and one or more tapered arms 402 (for example, 9 tapered arms 402) radiating outwardly from the central region 400. The arms are arranged symmetrically about the central region 400 with corresponding tips 405 of the arms (at the end of each arm 402) being narrower than the base portion or attachment point connecting the arm 402 to the central region 400. The arms need not be tapered in some embodiments. Note that for the purposes of illustration, not every element is labeled in FIG. 4. The reader will understand that the mounting plate 401 is symmetric and elements are repeated around the mounting plate 401 several times. The mounting plate 401 can have an overall width between 15 inches and 18 inches (for example, it may be sized such that an imaginary circle contacting each of the tips 405 has a diameter between 15 inches and 18 inches), or it can have other suitable dimensions.

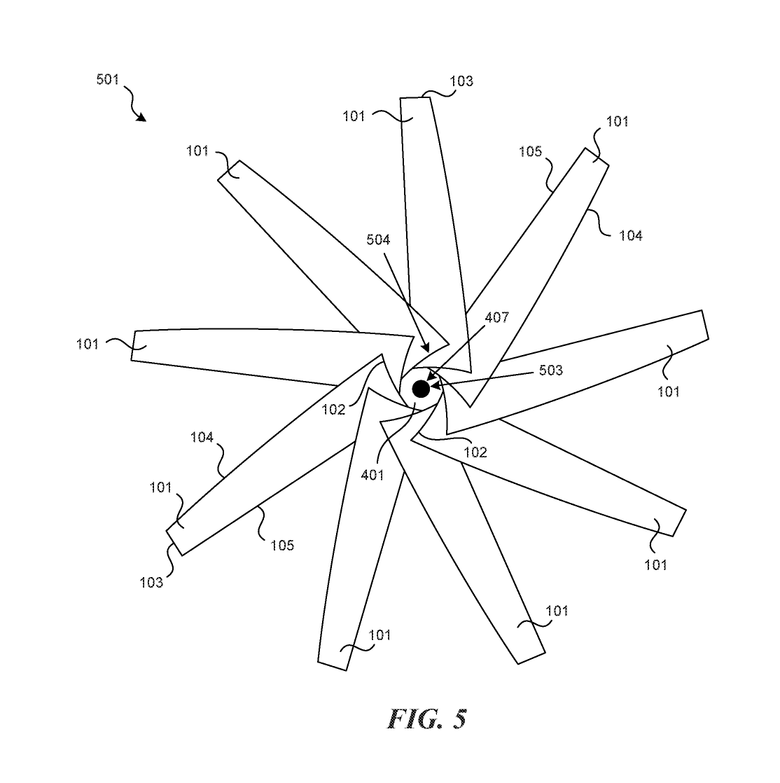

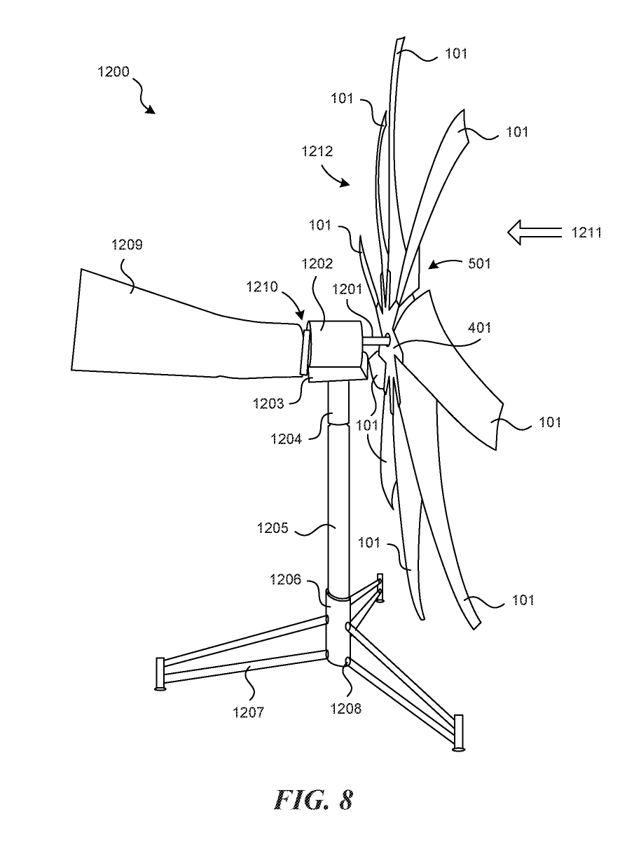

Each arm 402 includes a first edge 403 and a second edge 404 opposite the first edge 403. Mounting holes 406 are positioned near the first edge 403. The mounting holes 406 are positioned to align with corresponding mounting holes on the turbine blades described above (for example, mounting holes 106 in the turbine blades 101 described above with respect to FIGS. 1-3). When the mounting holes on the turbine blades are mated with the mounting holes 406 on the mounting plate 401, the trailing edge of each turbine blade (for example, the trailing edge 105 of the turbine blade 101 described above with respect to FIGS. 1-3) aligns with the first edge 403 of the mounting plate 401. The mounting holes 406 of the mounting plate 401 are spaced apart from a center region 407 of the mounting plate 401 by a distance 408 such that when the blades are mounted on the mounting plate 401 there is a central open region at the base of the blades near the roots of each blade (see FIG. 5) to allow air flow to the center region 407 of the mounting plate for cooling an attached generator (see FIG. 8). An opposite side of the mounting plate center region 407 can connect to a drive shaft of a generator.

In various embodiments, the mounting plate 401 is formed from a stiff material such as steel or plastic. In other embodiments, the mounting plate 401 can be formed from a variety or combination of materials suitable to support turbine blades and carry loads to transfer torque to a generator. For example, the mounting plate 401 can be formed from steel with a thickness between 3/16 of an inch and 0.5 inches, or other suitable dimensions depending on material, implementation, and blade size. In a representative embodiment, the mounting plate 401 is ⅜ of an inch thick. One or more bolts (not shown) pass through the turbine blades and the mounting plate 401 to secure the turbine blades to the mounting plate 401. In other embodiments, other suitable fasteners can be used.

FIG. 5 generally illustrates a partially schematic front view of a turbine 501 constructed using the turbine blades 101 shown in FIGS. 1-3 and the mounting plate 401 shown in FIG. 4, in accordance with an embodiment of the present technology. The blades 101 are connected to the mounting plate 401 by aligning the mounting holes on the blades (mounting holes 106) with the mounting holes on the base plate (mounting holes 406) (neither are shown in FIG. 5, but are shown in FIGS. 1-4). Bolts with nuts can be used to mount, clamp, or connect the turbine blades 101 to the mounting plate 401. Other suitable fasteners, such as rivets, pins, or clips, can additionally or alternatively be used to mount the turbine blades 101 to the mounting plate 401. Once connected, the location of the mounting holes results in a stiffening of the blades 101 along the trailing edge 105. The mounting holes are located such that the roots 102 of the turbine blades 101 are spaced apart and leave an opening at the center region 503 of the turbine (corresponding generally to the center region 407 of the mounting plate 401. Such an attachment or mounting results in a symmetrical overlapping pattern for the blades 101, in which the leading edge 104 of each blade overlaps its neighboring blade 101. The symmetrical pattern also results in all the tips 103 of the blades 101 being equidistant apart and each an equal distance from the center region 503 of the turbine. The curvature of the blades 101 is such that the blade faces are concave in the view of FIG. 5. The convex sides opposite the blade faces are positioned toward the mounting plate 401 and downstream of normal wind during use (the concave faces resist bending backwards away from the wind during normal operation).

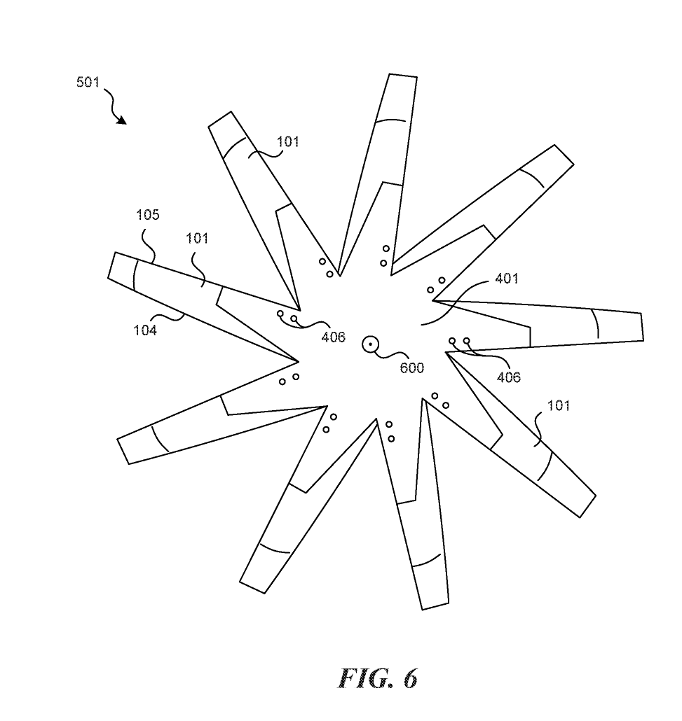

FIG. 6 generally illustrates a partially schematic rear view of the turbine 501, in which the turbine blades 101, mounting plate 401, and mounting holes 406 of the mounting plate 401 are visible. Such a view is looking upstream and at the convex sides of the blades 101. The rear side of the mounting plate 401 can include a recess 600 to receive a drive shaft associated with a generator, described in further detail below. For illustration, the leading edge 104 and the trailing edge 105 of one of the blades 101 are indicated.

The mounting plate 401 described above with respect to FIGS. 4-6 holds the blades 101 in an optimum orientation for capturing wind energy. The blades are mounted using a strategically placed set of mounting holes (such as mounting holes 106, 406 described above) that provide for proper orientation of the individual blades relative to one another and to the wind direction. The mounting arrangement, along with the compound curvature of the blades (described above, such as an at least partially parabolic shape) provides structural integrity. The tensile strength of the HDPE material of the blades 101 between the mounting bolts (in mounting holes 106) intensifies the strength of the mounting plate 401 at the base of the blades 106. The mounting arrangement on a directional radial hub provides good airflow bypass closer to the blade roots 102 and to the selected alternator or generator (such as a permanent magnet alternator) for cooling. The rear side of the mounting plate 401 can include a recess 600 to receive a drive shaft associated with a generator, described in further detail below.

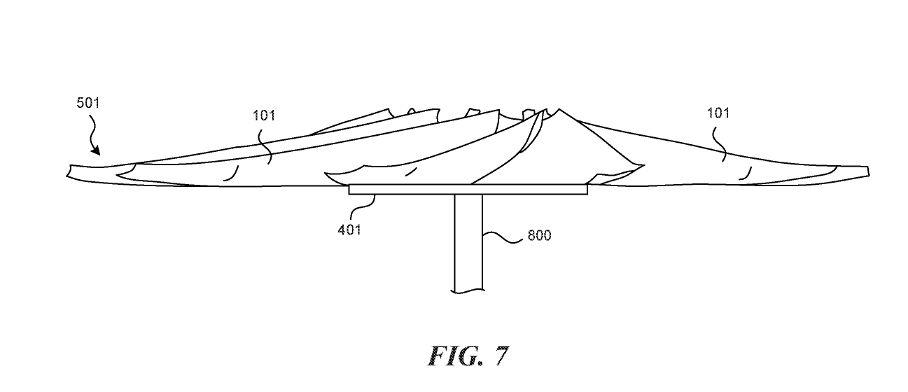

In some embodiments of the present technology, the mounting plate 401 connects to a generator or alternator to create electricity from rotation due to the wind. For example, FIG. 7 generally illustrates a side view of a turbine (such as a turbine 501 described above with respect to FIGS. 5-6), in which the turbine is attached to a drive shaft 800. The drive shaft 800 connects to an alternator, generator, or other suitable device for converting rotation to electrical energy. The drive shaft 800 can have a diameter of approximately ¾ inch, depending on implementation.

### Wind Turbine and Generator Assembly

One representative advantage of blades 101 in accordance with the present technology is that they produce high torque relative to their profile and size. Accordingly, blades 101 and turbines (such as the turbine 501 described above with respect to FIGS. 5-7) in accordance with the present technology can be used in many remote or dedicated applications, such as cabins, camp sites, boats, remote environmental monitors, etc. Small wind turbines and electric generators powered by small wind turbines can be environmentally sound and economically attractive alternatives to conventional sources of energy. Representative blades and turbines in accordance with the present technology have improved efficiency for converting mechanical energy derived from the wind into electrical energy and they are able to operate in both low wind and high wind conditions with reduced (e.g., minimal) noise. Various wind turbines according to the present technology can have an outer diameter of 24 inches to 80 inches, or other suitable dimensions, depending on application and need for portability.

In another embodiment, a wind turbine in combination with an alternator/generator is mounted to a collapsible stand such that the turbine generator and stand are portable.

For example, FIG. 8 illustrates a representative wind turbine generator assembly 1200. The wind turbine generator assembly 1200 includes a turbine (such as a turbine 501 described above) including a plurality of turbine blades 101 mounted to the mounting plate 401 attached to the drive shaft 1201 (which may be similar to the drive shaft 800 described above with respect to FIG. 7) of a generator 1202. The drive shaft 1201 is attached to the center of the mounting plate 401 on the side opposite the turbine blades 101.

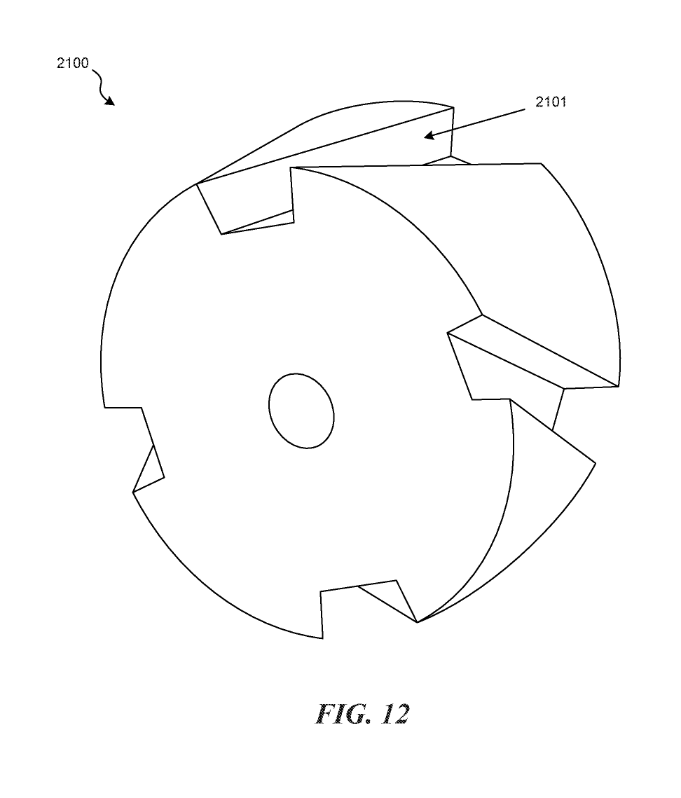

The generator 1202 can be mounted to a bracket 1203 which can in turn be supported on an upper support shaft 1204. The upper support shaft 1204 can fit onto a lower support shaft 1205 of a tripod support 1206. The tripod support 1206 may include a plurality of legs 1207 (for example, 3, or another suitable number) to stably support the wind turbine generator. The illustrated embodiment in FIG. 12 represents a portable version of a wind turbine generator. In another embodiment the lower support shaft 1205 may be fixed to the ground or to another suitable support structure to provide a more permanently located wind turbine generator. In a representative embodiment the legs 1207 of the tripod support 1206 can be attached to the tripod support 1206 using attachments points 1208 that enable the legs to be removed for easy transportation. Although two support shafts (1204, 1205) are illustrated, any suitable number of support shafts can be used in various embodiments.

In another embodiment, the attachment points 1208 can pivot such that the legs 1207 may be folded upward and inward towards each other thereby making a compact structure for transport of the wind turbine generator. The wind turbine generator assembly 1200 can further include a fin 1209 attached to the mounting bracket 1203 with an attachment mechanism 1210. The fin helps keep the wind turbine generator pointing in a direction facing the wind direction 1211 for capturing wind energy to rotate the turbine and generator thereby generating electrical energy by the generator 1202. In one embodiment, the attachment mechanism 1210 for the fin 1209 is a breakaway attachment such that in extreme winds the fin breaks away, the turbine rotates such that the backsides 1212 of the blades 101 face the wind direction 1211 and the blades 101 can fold under wind to protect the wind turbine generator from permanent damage.

In another embodiment the mount 1203 is a pivot mount and if the fin 1209 breaks away in extreme winds the weight of the generator 1202 causes the turbine and generator to pivot such that the turbine is in a horizontal position (at right angles to the normal operating position shown), thereby the turbine 501 presents an edge-on profile to the wind direction 1211, protecting the wind turbine generator from damage in high winds.

Accordingly, in a representative embodiment, a nine-blade turbine is collapsible and small enough to be carried by a human to remote locations, and efficiently generates power at low wind speeds.

The wind turbine generator assembly can include various suitable alternators or generators for converting rotational motion to electric energy. For example, in some embodiments, when a turbine according to the present technology is connected to a suitable alternator or generator, the wind turbine generator assembly may produce between 750 watts and 3 kilowatts.

Permanent Magnet Alternator with Non-magnetic Rotor

The present technology also relates to a radial flux permanent magnet alternator and particularly to a rotor construction for such an alternator using non-magnetic material to increase the magnetic flux cutting the stator windings. Such an alternator and/or rotor can be used with a wind turbine generator assembly according to the present technology, or it may be used in other applications for generating electrical energy and/or electrical power. Note that although a representative alternator is described herein, the wind turbine generator assemblies described herein and according to the present technology may use any suitable alternator.

A representative feature of the technology is that the rotor of a radial flux, permanent magnet alternator is fabricated from a strong, light weight non-magnetic material. One non-limiting example of such a material is a composite employing carbon fibers and glass fibers in an epoxy base. Such composites have demonstrated exceptional strength and durability combined with light weight for demanding applications in the automotive, medical and industrial industries. Additionally, these composites are relatively easy to form into precise, complex shapes without the need for precision stamping or milling operations.

The inventor discovered that the use of non-magnetic material in the rotor is that, owing to the smaller magnetic permeability of the material, the magnetic flux that normally flows through the rotor walls separating the magnets is now directed through the stator teeth and the stator body, thus cutting the stator windings and contributing to higher power generation efficiency. Besides exhibiting lighter unit weight, the use of non-magnetic material increases the power generation efficiency of the unit because the portion of magnetic flux that shunts the stator windings is reduced.

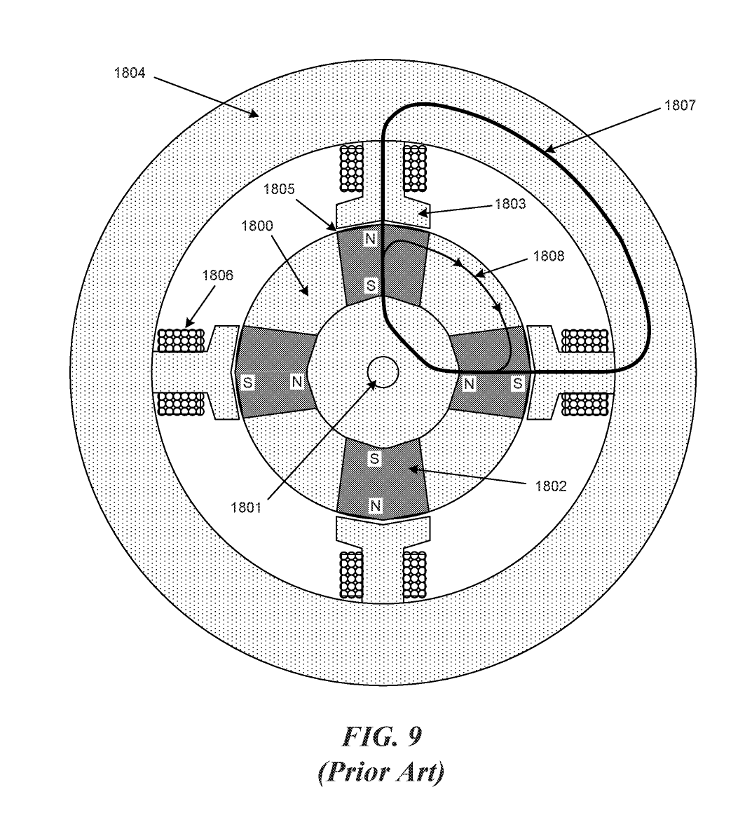

FIG. 9 illustrates a prior art permanent magnet alternator. Permanent magnets 1802 are attached to cylindrical rotor body 1800 which is constructed of magnetic material and which is attached to rotor shaft 1801. The outermost poles of the magnets 1802 are separated by a small air gap 1805 from stator teeth 1803 which are attached to cylindrical stator body 1804 thus allowing the rotor assembly to rotate freely via rotor shaft 1801 with respect to the stator assembly. Coils 1806 are wound around stator teeth 1803 in which currents are induced by the time-varying magnetic flux 1807 from the rotating magnets 1802. However, because the rotor body 1800 is constructed from magnetic material, a portion of the magnetic flux 1808 produced by the magnets is shunted through the rotor body 1800 and around the coils 1806, resulting in a reduction in efficiency of operation of the alternator.

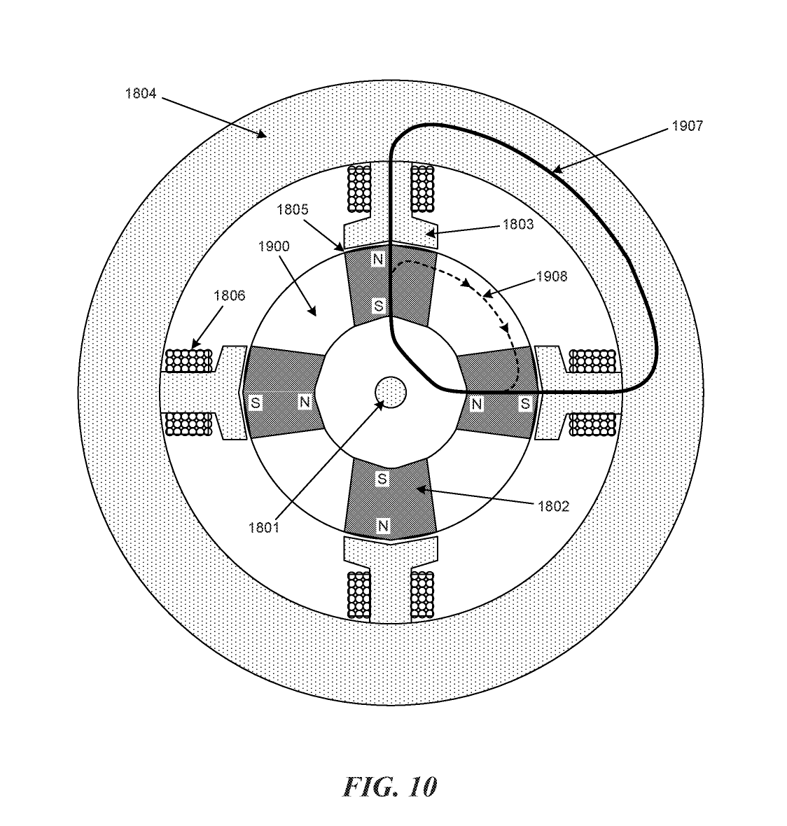

FIG. 10 illustrates one embodiment of an improved permanent magnet alternator. Permanent magnets 1802 are attached to cylindrical rotor body 1900 which is constructed of non-magnetic material and which is attached to rotor shaft 1801. The outermost poles of the magnets 1802 are separated by a small air gap 1805 from stator teeth 1803 which are attached to cylindrical stator body 1804 thus allowing the rotor assembly to rotate freely via rotor shaft 1801 with respect to the stator assembly. Coils 1806 are wound around stator teeth 1803 in which currents are induced by the time-varying magnetic flux 1907 from the rotating magnets 1802. However, because the rotor body 1900 is constructed from non-magnetic material, the shunt flux 1908 is greatly reduced in magnitude, thereby increasing the magnitude of the magnetic flux 1907 coupled to the coils 1806 and thus increasing the efficiency of the alternator.

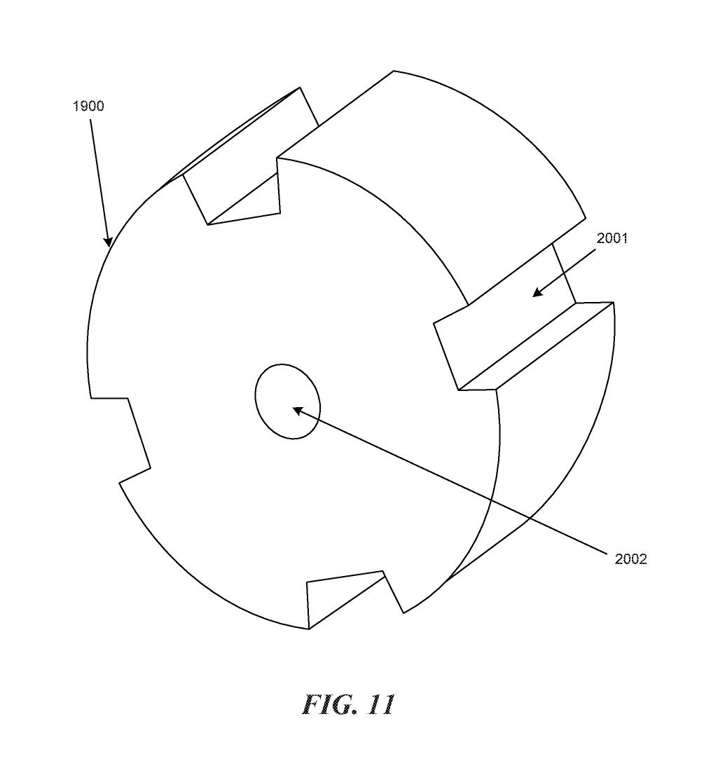

FIG. 11 shows an isometric drawing of the non-magnetic rotor 1900 shown in FIG. 10. The non-magnetic rotor 1900 includes slots 2001 for mounting the permanent magnets 1802 and a hole 2002 for attachment of the rotor shaft 1801.

FIG. 12 shows an isometric drawing of a non-magnetic rotor 2100 similar to the non-magnetic rotor described above with respect to FIG. 10 in which the magnet slots 2101 are skewed in order to reduce the cogging torque of the alternator, thereby reducing the wind forces required to initiate energy production.

Alternators according to embodiments of the present technology can include a suitable number of magnets (such as 14 magnets, for example) mounted in a corresponding number of skewed slots.

From the foregoing, it will be appreciated that specific embodiments of the disclosed technology have been described for purposes of illustration, but that various modifications may be made without deviating from the technology, and elements of certain embodiments may be interchanged with those of other embodiments. For example, representative embodiments disclosed herein and illustrated in the accompanying figures show portions of assemblies and assemblies with a nine-blade turbine generator. In other embodiments, turbines can include any suitable number of blades and the mounting plates can include any suitable corresponding number of arms (such as 7, 8, 10, 11, or 12 arms and blades). In some embodiments, dimensions may be scaled up or down while maintaining an 18 degree washout angle. In other embodiments, the washout angle may be suitably modified.

Further, while advantages associated with certain embodiments of the disclosed technology have been described in the context of those embodiments, other embodiments may also exhibit such advantages, and not all embodiments need necessarily exhibit such advantages to fall within the scope of the technology. Accordingly, the disclosure and associated technology may encompass other embodiments not expressly shown or described herein, and the invention is not limited except as by the appended claims.

What is claimed is:

1. A wind turbine generator assembly for converting wind into electrical energy, the assembly comprising
a wind turbine;
a generator positioned to support the wind turbine and configured to receive rotational force from the wind turbine and convert the rotational force to electrical energy;
a fin connected to the generator and positioned on a side of the generator opposite the wind turbine; and
a support structure positioned to support the generator, the support structure configured to allow the generator to rotate relative to the support structure; wherein
the wind turbine comprises:
a mounting plate having a central region and a plurality of arms extending outwardly from the central region, wherein the plurality of arms is arranged symmetrically around the central region and each arm includes at least one mounting hole; and
a plurality of turbine blades, each turbine blade being connected to a corresponding arm of the plurality of arms via a corresponding mounting hole of the at least one mounting hole; and wherein
at least one of the turbine blades comprises
an elongated quadrilateral sheet including
a root,
a tip positioned opposite the root,
a leading edge spanning between the root and the tip along a length of the blade, and
a trailing edge positioned opposite the leading edge and spanning between the root and the tip along the length of the blade; wherein
the blade has a radius of curvature along its length forming a concave face oriented away from the mounting plate; and
the root and the tip are rotated relative to each other such that the blade is twisted along its length.

2. The wind turbine generator assembly of claim 1 wherein the support structure comprises a shaft connected to a tripod.

3. A wind turbine comprising:
a mounting plate having a central region and a plurality of arms extending outwardly from the central region, wherein the plurality of arms is arranged symmetrically around the central region and each arm includes at least one mounting hole; and
a plurality of turbine blades, each turbine blade being connected to a corresponding arm of the plurality of arms via a corresponding mounting hole of the at least one mounting hole; wherein
at least one of the turbine blades comprises
an elongated quadrilateral sheet including
a root,
a tip positioned opposite the root,
a leading edge spanning between the root and the tip along a length of the blade, and
a trailing edge positioned opposite the leading edge and spanning between the root and the tip along the length of the blade; wherein
the blade has a radius of curvature along its length forming a concave face oriented away from the mounting plate; and
the root and the tip are rotated relative to each other such that the blade is twisted along its length.

4. The wind turbine of claim 3 wherein the root and the tip are rotated relative to each other by a washout angle of 18 degrees.

5. The wind turbine of claim 3 wherein each blade of the plurality of blades partially overlaps another blade of the plurality of blades.

6. The wind turbine of claim 3 comprising nine arms and nine blades.

7. The wind turbine of claim 3 wherein the arms are tapered along their length and the leading edge of the at least one turbine blade is aligned with an edge of its corresponding arm.

8. The wind turbine of claim 3 wherein the blade comprises hexene copolymer high density polyethylene.

9. The wind turbine of claim 3 wherein the at least one turbine blade is attached to its corresponding arm via a portion of the turbine blade that is closer to the trailing edge than to the leading edge.

10. A blade for a wind turbine, the blade comprising:
an elongated quadrilateral sheet including
a root,
a tip positioned opposite the root,
a leading edge spanning between the root and the tip along a length of the sheet, and
a trailing edge positioned opposite the leading edge and spanning between the root and the tip along the length of the sheet; wherein
the sheet is curved about a longitudinal axis such that the root is curved, the tip is curved, and a region between the tip and the root is curved; and wherein
the tip is twisted relative to the root by a washout angle of between 16 and 20 degrees.

11. The blade of claim 10 wherein the washout angle is 18 degrees.

12. The blade of claim 10 wherein a radius of curvature of the root is equal to a radius of curvature of the tip.

13. The blade of claim 12 wherein the radius of curvature of the root is 7 inches.

14. The blade of claim 10 wherein the root is longer than the tip.

15. The blade of claim 10 wherein at least a portion of the trailing edge is straight and the leading edge has a radius of curvature between the root and the tip.

16. The blade of claim 15 wherein the radius of curvature of the leading edge is 10 feet.

17. The blade of claim 10 wherein the blade comprises hexene copolymer high density polyethylene.

18. The blade of claim 10 wherein a ratio of a length of the trailing edge to a width of the root to a width of the tip is 8:2:1.

19. The blade of claim 10 wherein at least part of the curve of the sheet about the longitudinal axis is parabolic.

20. The blade of claim 10 wherein:
the washout angle is 18 degrees;
a radius of curvature of the root is 7 inches;
a radius of curvature of the tip is 7 inches;
the leading edge has a radius of curvature between the root and the tip of 10 feet;
the blade has an overall length between 24 and 34.5 inches; and
the blade comprises high density polyethylene (HDPE).
